(19) United States
(12) Patent Application Publication
(10) Pub. No.: US 2014/0277597 A1
(43) Pub. Date: Sep. 18, 2014

(54) SYSTEM AND METHOD FOR MANAGING INDUSTRIAL PROCESSES

(71) Applicants: Aurelien Le Sant, Melrose, MA (US); Michael Crowley, Sandwich, MA (US); Christopher Carey Wilkins, Haverhill, MA (US)

(72) Inventors: Aurelien Le Sant, Melrose, MA (US); Michael Crowley, Sandwich, MA (US); Christopher Carey Wilkins, Haverhill, MA (US)

(73) Assignee: SCHNEIDER ELECTRIC INDUSTRIES SAS, Rueil-Malmaison (FR)

(21) Appl. No.: 14/352,150

(22) PCT Filed: Dec. 30, 2011
(86) PCT No.: PCT/US2011/068135

§ 371 Date: Apr. 16, 2014

Related U.S. Application Data
(60) Provisional application No. 61/550,795, filed on Oct. 24, 2011.

(51) Int. Cl. G05B 15/02

(52) U.S. Cl. CPC G05B 15/02
USPC 700/17; 700/20

(57) ABSTRACT

According to at least one embodiment, a system for discovering, configuring and monitoring automatic control devices is provided. The system includes a mobile computing device that implements a control device interface. The control device interface provides a discovery request to at least one automatic control device in data communication with a network, the discovery request being encoded according to a first protocol; provides a request for identification to the at least one automatic control device, the request for identification being encoded according to a second protocol; and identifies the at least one automatic control device as an automatic control device based on the response to the request for identification. In this embodiment, the second protocol is an industrial protocol.

### RELATED APPLICATIONS

This application claims priority under 35 U.S.C. §119(e) to U.S. Provisional Application Ser. No. 61/550,795, entitled “SYSTEM AND METHOD FOR MANAGING INDUSTRIAL PROCESSES,” filed on Oct. 24, 2011, which is hereby incorporated herein by reference in its entirety.

### BACKGROUND

1. Technical Field

The technical field of this disclosure relates generally to control systems and, more particularly, to systems and methods that provide securely provide access to information regarding the operation of automatic control devices to geographically disparate users.

2. Background Discussion

An industrial control system often includes a programmable logic controller (PLC) for providing coordinated control of industrial control equipment. Examples of industrial control equipment include sensors for providing inputs to the PLC or relays for receiving outputs from the PLC, each under the control of an element controller, and each connected to the PLC over a network via a network I/O device. Industrial control using a PLC typically requires what is termed rapid scanning, meaning the continuous, rapid execution by the PLC of three main steps executed repeatedly: the acquiring of the status of each input to the PLC needed to execute so-called ladder logic for the process being controlled, the solving of the ladder logic to determine each output, and the updating of the status of the outputs. For predictable and effective industrial control, a PLC scans the connected I/O devices at a constant scan rate, and avoids becoming so involved in peripheral tasks as to depart from its regularly scheduled monitoring of the I/O devices.

The term ladder logic is used to indicate, in a form recognizable to early workers in the field of machine control, the expression of how the control elements of an industrial control system are to be controlled based on the monitoring elements of the industrial control system. The term ladder is used because the expression of the control logic is actually often in the form of a ladder, with each rung of the ladder having an output, i.e. a value for the required state of a control element, and one or more inputs, i.e. values corresponding to signals from monitoring elements.

Ordinarily, process operation is monitored, at least intermittently, by supervisory personnel via one or more central management stations. Each station samples the status of PLCs (and their associated sensors) selected by the operator and presents the data in some meaningful format. The management station may or may not be located on the same site as the monitored equipment; frequently, one central station has access to multiple sites (whether or not these perform related processes). Accordingly, communication linkage can be vital even in traditional industrial environments where process equipment is physically proximate, since at to least some supervisory personnel may not be.

To facilitate the necessary communication, the PLCs and related monitoring stations are connected by a computer network. Typically, a network is organized such that any computer may communicate with any other network computer. The communication protocol provides a mechanism by which messages can be decomposed and routed to a destination computer identified by some form of address. The protocol may place a “header” of routing information on each component of a message that specifies source and destination addresses, and identifies the component to facilitate later reconstruction of the entire message by the destination computer. This approach to data transfer permits the network to rapidly and efficiently handle large communication volumes without reducing transfer speed in order to accommodate long individual messages, or requiring every network computer to process every network message. The degree of routing depends on the size of the network. Each computer of a local network typically examines the header of every message to detect matches to that computer's identifier; multiple-network systems use routing information to first direct message components to the proper network.

### SUMMARY

At least some aspects and embodiments disclosed herein provide for a computer system through which a PLC or other automatic control device provides information regarding industrial processes managed by the automatic control device or information regarding the automatic control device, itself. Examples of automatic control devices include PLCs, input/output modules, regulation devices, monitoring and control stations, man-machine dialogue terminals, intelligent sensor/actuators or any other equipment related at an automatic control application.

According to at least one embodiment, a system for discovering, configuring and monitoring automatic control devices is provided. The system includes a mobile computing device. The mobile computing device includes a memory, a network interface in data communication with a network, at least one processor coupled to the memory and the network interface, and a control device interface executed by the at least one processor. The control device interface is configured to provide, via the network interface, a discovery request to at least one automatic control device of a plurality of automatic control devices in data communication with the network, the discovery request being encoded according to a first protocol; receive, via the network interface, a response to the discovery request from the at to least one automatic control device; provide, via the network interface, a request for identification to the at least one automatic control device, the request for identification being encoded according to a second protocol; receive, via the network interface, a response to the request for identification from the at least one automatic control device; and identify the at least one automatic control device as an automatic control device based on the response to the request for identification. The second protocol is an industrial protocol.

In the mobile computing device, the control device interface may be implemented as a native application resident on the mobile computing device. The system may further include the at least one automatic control device and the at least one automatic control device may execute a web server. The control device interface may be implemented via the web server and a web-browser resident on the mobile computing device.

In the system, the second protocol may be at least one of MODBUS, UMAS, TCP/IP over Ethernet, BACnet, LON, C-BUS, DMX512, JCI-N2, and ZigBee. The mobile computing device may include a user interface and the control device interface may be further configured to display a representation of the at least one automatic control device within the user interface. The control device interface may be further configured to receive alert information and present a push notification including a representation of the alert information via the user interface. The control device interface may be further configured to receive alert information, store an alert representative of the alert information, and present the alert via the user interface upon subsequent activation of the control device interface.

In another embodiment, a method of discovering automatic control devices using a mobile computing device is provided. In this embodiment, the mobile computing device implements a control device interface. The method includes acts of providing, via the control device interface, a discovery request to at least one automatic control device of a plurality of automatic control devices in data communication with the network, the discovery request being encoded according to a first protocol; receiving a response to the discovery request from the at least one automatic control device; providing a request for identification to the at least one automatic control device, the request for identification being encoded according to a second protocol; receiving a response to the request for identification from the at least one automatic control device; and identifying the at least one automatic control device as an automatic control device based on the response to the request for identification. The second protocol is an industrial protocol.

In the method, the act of providing, via the control device interface, the discovery to request may include an act of providing the discovery request via a native application resident on the mobile computing device. The act of providing, via the control device interface, the discovery request may include an act of providing the discovery request via a web-browser resident on the mobile computing device. The act of providing the request for identification may include an act of providing a request for identification using at least one of MODBUS, UMAS, TCP/IP over Ethernet, BACnet, LON, C-BUS, DMX512, JCI-N2, and ZigBee.

The method may further include an act of displaying a representation of the at least one automatic control device within a user interface. The method may further include acts of receiving alert information and presenting a push notification including a representation of the alert information via a user interface. The method may further include acts of receiving alert information, storing an alert representative of the alert information, and presenting the alert via a user interface upon subsequently activating the control device interface.

In another embodiment, a non-transitory computer readable medium is provided. The computer readable medium has stored thereon sequences of instruction for discovering automatic control devices in data communication with a network. The sequences of instruction include instructions that will cause at least one processor of a mobile computing device to provide a discovery request to at least one automatic control device of a plurality of automatic control devices in data communication with the network, the discovery request being encoded according to a first protocol; receive a response to the discovery request from the at least one automatic control device; provide a request for identification to the at least one automatic control device, the request for identification being encoded according to a second protocol; receive a response to the request for identification from the at least one automatic control device; and identify the at least one automatic control device as an automatic control device based on the response to the request for identification. The second protocol is an industrial protocol.

The instructions may cause the at least one processor to implement a native application on the mobile computing device. The instructions may cause the at least one processor to encode the request for identification using at least one of MODBUS, UMAS, TCP/IP over Ethernet, BACnet, LON, C-BUS, DMX512, JCI-N2, and ZigBee. The instructions may further instruct the at least one processor to display a representation of the at least one automatic control device within a user interface. The instructions further instruct the at least one processor to receive alert information and present a push notification including a to representation of the alert information via the user interface. The instructions may further instruct the at least one processor to receive alert information, store an alert representative of the alert information, and present the alert via a user interface upon subsequent activation of a control device interface.

Other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment or example.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a schematic diagram including an exemplary automation monitoring system;

FIG. 2 is a schematic diagram of an exemplary computer system that may be configured to perform processes and functions disclosed herein;

FIG. 3 is a flow diagram illustrating a process of discovering automatic control devices (“ACDs”);

FIG. 4 is a flow diagram illustrating a process of processing alerts generated by automatic control devices;

FIG. 5 is an exemplary user interface screen configured to provide information regarding automatic control devices;

FIG. 6 is an exemplary user interface screen configured to receive login information;

FIG. 7 is an exemplary user interface screen configured a menu of information and options; and

FIG. 8 is an exemplary user interface screen configured to push notification.

### DETAILED DESCRIPTION

At least some embodiments disclosed herein include apparatus and processes for discovering and managing one or more automatic control devices in data communication with a network. For instance, according to some embodiments, a mobile computing device, such as a tablet computer or smart phone, establishes communications with a local area network and discovers one or more automatic control devices in data communication with the network. In these embodiments, the mobile computing device communicates directly with the automatic control devices and configures one or more operational parameters specified within configuration information stored in the automatic control devices. In addition, in some of these embodiments, the mobile computing device is configured to receive alerts generated by the automatic control devices during their operation.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Local Network-based Automation Control System

Some embodiments implement an automation control system that provides for discovery, configuration, and monitoring of automatic control devices via a local area network using one or more computer systems. FIG. 1 illustrates one of these embodiments, an automation control system 100. As shown in FIG. 1, the automation control system 100 includes a mobile computing device 106, automatic control devices 108, 110, 112, and 114, and a local network 116. The mobile computing device 106 includes a known device information data storage 122 and two control device interfaces 124: a browser 118 and a native client 120. In the example shown in FIG. 1, the automation control system 100 and a user 104 of the mobile computing device 106 are located within a physical location 102 (e.g., a manufacturing plant).

According to the example illustrated in FIG. 1, the mobile computing device 106 and the automatic control devices 108, 110, 112, and 114 are in data communication with one another via the local network 116. The local network 116 may include any network through which computer systems may exchange (i.e., send or receive) information. For example, the local network 116 may be an Ethernet LAN running MODBUS/TCP. Alternatively, the local network 116 may be implemented using a variety of industrial protocols including UMAS, BACnet, LON, C-BUS, TCP/IP over Ethernet, DMX512 and JCI-N2, and wireless protocols, such as ZigBee and Bluetooth. In some embodiments, the mobile computing device 106 may couple to the local network 116 via a virtual private network (“VPN”) connection established through the internet. In other embodiments, the mobile computing device 106 may connect to the internet using a telecommunications standard such as any of several Groupe Special Mobile (“GSM”) or Code Division Multiple Access (“CDMA”) based standards.

Also as depicted in FIG. 1, the browser 118 exchanges information with the known device information data storage 122 and the user 104. The native client 120 also exchanges information with the known device information data storage 122 and the user 104.

The information exchanged between the mobile computing device 106 and the automatic control devices 108, 110, 112, and 114 via the local network 116 may include any information descriptive of the mobile computing device 106, the automatic control devices 108, 110, 112, and 114, or the equipment and processes controlled by the automatic control devices. For instance, each of the automatic control devices 108, 110, 112, and 114 may store and exchange ACD information descriptive of its configuration or the configuration of other automatic control devices. Examples of this ACD information may include one or more identifiers of an automatic control device (e.g., a serial number, model number, or a media access control (“MAC”) address, a device name or internet protocol (“IP”) address), a current state of an automatic control device, diagnostic information that may be used to determine how an automatic control device entered its current state, ladder logic that the automatic control device is configured to execute, version information of hardware and software components included in an automatic control device, parameters that specify the operational behavior of an automatic control device, authentication information for gaining access to the local network 116 (e.g., security keys), information describe events of importance that cause an automatic control device to transmit an alert (e.g., where the value of a monitored variable transgresses a predetermined threshold value), and historical information regarding an automatic control device. Additional examples of ACD information include data descriptive of one or more industrial processes managed by an automatic control device (e.g., status or measurement information as stored in one or more table variables). In some embodiments, the information exchanged between the mobile computing device 106 and the automatic control devices 108, 110, 112, and 114 includes other information such as login credentials or data summarized from ACD information.

Within the example illustrated in FIG. 1, the known device information data storage 122 includes a variety of data structures and data elements that store information descriptive of automatic control devices previously discovered by the mobile device 106. Examples of the information stored in the known device information data storage 122 include device name, IP address, and login credentials (e.g., username and password).

Information within the components of the automation control system 100 may be stored in any logical construction capable of holding information on a computer readable medium including, among other structures, file systems, flat files, indexed files, hierarchical databases, relational databases or object oriented databases. The data may be modeled using unique and foreign key relationships and indexes. The unique and foreign key relationships and indexes may be established between the various fields and tables to ensure both data integrity and data interchange performance.

According to a variety of embodiments, the automation control system 100 includes components configured to discover, configure, and monitor the automatic control devices 108, 110, 112, and 114 using the mobile computing device 106. For example, in some embodiments, the mobile computing device 106 implements the control device interface 124 that discovers automatic control devices coupled to the local network 116 and displays a list of the discovered devices to the user 104 via a user interface. One example of a discovery process executed by the control device interface 124 is described further below with reference to FIG. 3.

The control device interface 124 may be implemented using the browser 118 or the native client 120. For instance, according to one embodiment, the mobile computing device is configured to implement the control device interface 124 by executing the browser 118. According to this embodiment, the automatic control devices 108, 110, 112, and 114 include a web server that serves a user interface to the browser 118. The user interface provides and receives ACD information stored on the automatic control devices 108, 110, 112, and 114. Responsive to receiving modifications to the ACD information via the user interface, the web server stores the modifications within the locally stored ACD information, thereby enabling the user 104 to monitor and control the automatic control devices 108, 110, 112, and 114. In addition, in this embodiment, the user interface provides links to websites served by other automatic control devices that are in data communication with the local network 116, thereby decreasing the number of steps required for a user to navigate ACD information for automatic control devices located within a particular physical location, such as the location 102.

In another embodiment, the mobile computing device 106 is configured to implement the control device interface 124 by executing the native client 120. The native client 120 is a specialized client program 120 designed to utilize the specific characteristics (e.g., push notification and socket communication) of the mobile computing device 106. According to at least one embodiment, the native client 120 is configured to discover, configure, and monitor automatic control devices using an industrial protocol, such as MODBUS/TCP. Further, in this embodiment, the native client 120 communicates with the automatic control devices 108, 110, 112, and 114, without the use of an intermediate protocol converter or data aggregator.

In at least one embodiment, the user interface provided by the control device interface 124 is configured to receive an indication of an automatic control device that the user 104 wishes to monitor or configure. In response to receiving this indication, the control device interface 124 determines whether login credentials for the indicated automatic control device are stored in the known device information data storage 122. If so, the control device interface 124 establishes trusted communications with the indicated automatic control device using the known login credentials. Otherwise, the user interface provides a login screen, such as the login screen illustrated in FIG. 6, and receives login credentials. Then the control device interface 124 establishes trusted communications with the indicated automatic control device using the received login credentials and, where indicated to do so by the user interface, stores the received login credentials and an association between the received login credentials and the indicated automatic control device within the known device information data storage 122.

Next, the user interface displays a menu screen, such as the menu screen illustrated in FIG. 7, through which the control device interface 124 may receive indications to navigate to screens that display operational or configuration information of the indicated automatic control device. Using these screens, the control device interface 124 receives modifications to the configuration information and provides the modifications to the indicated automatic control device. After receiving the modifications, the indicated automatic control device stores the modifications within its ACD information, thereby altering its operational behavior.

In some embodiments, the automatic control devices 108, 110, 112, and 114 are configured to store, aggregate and summarize ACD information. Further, in these embodiments, the automatic control devices 108, 110, 112, and 114 are configured to issue an alert to the mobile computing device 106 in response to detecting an event of importance. In some of these embodiments, the native client 120 is configured to receive and display the alerts to the user according to the user's stored preferences. Thus, these embodiments do not include an intermediate device that serves as a data aggregator or consolidator for alert information. One example of an alert handling process performed by the native client 120 is described further below with reference to FIG. 4.

Information may flow between the components of the automation control system 100, or any of the elements, components and subsystems disclosed herein, using a variety of techniques. Such techniques include, for example, passing the information over a network using standard protocols, such as TCP/IP or HTTP, passing the information between modules in memory and passing the information by writing to a file, database, data store, or some other non-volatile data storage device. In addition, pointers or other references to information may be transmitted and received in place of, in combination with, or in addition to, copies of the information. Conversely, the information may be exchanged in place of, in combination with, or in addition to, pointers or other references to the information. Other techniques and protocols for communicating information may be used without departing from the scope of the examples and embodiments disclosed herein.

Embodiments of the automation control system 100 are not limited to the particular configuration illustrated in FIG. 1. Rather, various embodiments utilize a variety of hardware components, software components and combinations of hardware and software components configured to perform the processes and functions described herein. For instance, some examples of the mobile computing device 106 include smart phones (e.g., BLACKBERRY, IPHONE, RAZR, etc.), personal digital assistants, and tablet computing devices (e.g., IPAD, Android OS based Devices, etc.). Other examples of the mobile computing device 106 are described further below with reference to FIG. 2. Examples of the automatic control devices 108, 110, 112, and 114 shown in FIG. 1 include PLCs configured in accord with the PLC1 that is described in U.S. Pat. No. 6,640,140, entitled PLC EXECUTIVE WITH INTEGRATED WEB SERVER, issued Oct. 28, 2003, which is hereby incorporated herein by reference in its entirety. Other examples of the automatic control devices 108, 110, 112, and 114 shown in FIG. 1 include the automatic control devices described in commonly owned Patent Cooperation Treaty Application Number PCT/US11/68121, entitled “SYSTEMS AND METHODS OF REMOTE COMMUNICATION,” filed on even date herewith, which is hereby incorporated herein by reference in its entirety. Further, in some examples, the automation control system 100 is implemented using one or more computer systems, such as the computer systems described further below with regard to FIG. 2.

### Computer System

As discussed above with regard to FIG. 1, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 2, there is illustrated a block diagram of a distributed computer system 200, in which various aspects and functions are practiced. As shown, the distributed computer system 200 includes one more computer systems that exchange information. More specifically, the distributed computer system 200 includes computer systems 202, 204 and 206. As shown, the computer systems 202, 204 and 206 are interconnected by, and may exchange data through, a communication network 208. The network 208 may include any communication network through which computer systems may exchange data. To exchange data using the network 208, the computer systems 202, 204 and 206 and the network 208 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 202, 204 and 206 may transmit data via the network 208 using a variety of security measures including, for example, TLS, SSL or VPN. While the distributed computer system 200 illustrates three networked computer systems, the distributed computer system 200 is not so limited and may include any number of computer systems and computing devices, networked using any medium and communication protocol.

As illustrated in FIG. 2, the computer system 202 includes a processor 210, a memory 212, a bus 214, an interface 216 and data storage 218. To implement at least some of the aspects, functions and processes disclosed herein, the processor 210 performs a series of instructions that result in manipulated data. The processor 210 may be any type of processor, multiprocessor or controller. Some exemplary processors include commercially available processors such as an Intel Xeon, Itanium, Core, Celeron, or Pentium processor, an AMD Opteron processor, a Sun UltraSPARC or IBM Power5+ processor and an IBM mainframe to chip. The processor 210 is connected to other system components, including one or more memory devices 212, by the bus 214.

The memory 212 stores programs and data during operation of the computer system 202. Thus, the memory 212 may be a relatively high performance, volatile, random access memory such as a dynamic random access memory (DRAM) or static memory (SRAM). However, the memory 212 may include any device for storing data, such as a disk drive or other non-volatile storage device. Various examples may organize the memory 212 into particularized and, in some cases, unique structures to perform the functions disclosed herein. These data structures may be sized and organized to store values for particular data and types of data.

Components of the computer system 202 are coupled by an interconnection element such as the bus 214. The bus 214 may include one or more physical busses, for example, busses between components that are integrated within a same machine, but may include any communication coupling between system elements including specialized or standard computing bus technologies such as IDE, SCSI, PCI and InfiniBand. The bus 214 enables communications, such as data and instructions, to be exchanged between system components of the computer system 202.

The computer system 202 also includes one or more interface devices 216 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 202 to exchange information and to communicate with external entities, such as users and other systems.

The data storage 218 includes a computer readable and writeable nonvolatile, or non-transitory, data storage medium in which instructions are stored that define a program or other object that is executed by the processor 210. The data storage 218 also may include information that is recorded, on or in, the medium, and that is processed by the processor 210 during execution of the program. More specifically, the information may be stored in one or more data structures specifically configured to conserve storage space or increase data exchange performance. The instructions may be persistently stored as encoded signals, and the instructions may cause the processor 210 to perform any of the functions described herein. The medium may, for example, be optical disk, magnetic disk or flash memory, among others. In operation, the processor 210 or some other controller causes data to be read from the nonvolatile recording medium into another memory, such as the memory 212, that allows for faster access to the information by the processor 210 than does the storage medium included in the data storage 218. The memory may be located in the data storage 218 or in the memory 212, however, the processor 210 manipulates the data within the memory, and then copies the data to the storage medium associated with the data storage 218 after processing is completed. A variety of components may manage data movement between the storage medium and other memory elements and examples are not limited to particular data management components. Further, examples are not limited to a particular memory system or data storage system.

Although the computer system 202 is shown by way of example as one type of computer system upon which various aspects and functions may be practiced, aspects and functions are not limited to being implemented on the computer system 202 as shown in FIG. 2. Various aspects and functions may be practiced on one or more computers having a different architectures or components than that shown in FIG. 2. For instance, the computer system 202 may include specially programmed, special-purpose hardware, such as an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 202 may be a computer system including an operating system that manages at least a portion of the hardware elements included in the computer system 202. In some examples, a processor or controller, such as the processor 210, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 210 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Objective C, or Javascript. Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects, that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Automation Control System Processes

As described above with reference to FIG. 1, some embodiments perform processes that discover automatic control devices that are in data communication with a local network. In some embodiments, this discovery process is executed by a mobile computing device, such as the mobile computing device 106, or other computer system. One example of such a to process is illustrated in FIG. 3. According to this example, the discovery process 300 includes acts of issuing a discover request, receiving a response, determining a type of the responding devices and displaying representations of the automatic control devices that responded to the request.

In act 302, the mobile computing device issues a discovery request on the local network via execution of a control device interface, such as the native client 120 described above with reference to FIG. 1. The discovery request may take a variety of forms. For instance, in one embodiment, the discovery request is a series of pings sent to each allocated network address within the local network. In another embodiment, the discovery request is a broadcast message transmitted on the local network to every device in data communication with the local network. In still other embodiments, the discovery request may be implemented using UDP, Soap, and Device Profile for Web Services (“DPWS”). In any of these embodiments, an automatic control device that receives the discovery request transmits a response message that acknowledges receipt of the request. In one embodiment, the response message includes the network address of the automatic control device.

In act 304, the control device interface receives response messages from devices coupled to the local network. In act 306, the control device interface determines the device type of each device responding to the discovery request. In at least one embodiment, the control device interface makes this determination by transmitting a MODBUS/TCP message to each responding device that requests the device to identity its device type. After receiving this MODBUS/TCP message, each automatic control device in data communication with the local network responds with a MODBUS/TCP message that identifies the device as an automatic control device.

In act 308, the control device interface renders a user interface screen, such as the user interface screen described below with reference to FIG. 5. This user interface screen displays a representation of each automatic control device that responded with a message identifying the automatic control device as such, stores information identifying each automatic control device in a known device data storage, such as the known device data storage 122 described above with reference to FIG. 1, and the process discovery 300 ends.

Processes such as the discovery process 300 enable mobile computing devices to automatically identify automatic control devices that are in data communication with a local network. Such processes ease the administrative burden of locating, configuring, and monitoring automatic control devices, which may be particularly beneficial where the mobile computing device may be used to administer numerous automatic control devices located at a variety of physical locations.

As described above with reference to FIG. 1, some embodiments perform processes that handle alerts received from one or more automatic control devices. In some embodiments, this alert handling process is executed by a mobile computing device, such as the mobile computing device 106, or other computer system. One example of such a process is illustrated in FIG. 4. According to this example, the alert handling process 400 includes acts of receiving information describing an alert, determining whether the native client is configured to push alerts, queuing the alert, and reporting the alert.

In act 402, the mobile computing device receives information describing an alert via a control device interface, such as the native client 120 described above with reference to FIG. 1. In act 404, the control device interface determines whether it is configured to push alerts to a user interface of the mobile computing device. If so, the control device interface reports the alert in act 406, and the alert handling process 400 ends. FIG. 8 shows an example of an alert reporting screen displayed during execution of the act 406. If the control device interface is not configured to push alerts, in act 408 the control device interface stores the alert for later display by the mobile computing device, and the alert handling process 400 ends.

Processes such as the alert handling process 400 enable mobile computing devices to communicate alert information according to the preferences of the user. More particularly, such processes allow the mobile computing device to monitor automatic control devices and report alerts without requiring that the control device interface be in the foreground of the user interface of the mobile computing device.

Processes 300 and 400 each depict one particular sequence of acts in a particular example. The acts included in these processes may be performed by, or using, one or more computer systems or automatic control devices specially configured as discussed herein. Some acts are optional and, as such, may be omitted in accord with one or more examples. Additionally, the order of acts can be altered, or other acts can be added, without departing from the scope of the systems and methods discussed herein. Furthermore, as discussed above, in at least one embodiment, the acts are performed on particular, specially configured machines, namely an automation control system configured according to the examples and embodiments disclosed herein.

### User Interface Screens

As describe above, some embodiments disclosed herein render user interface screens that support an automatic control device discovery process on a mobile computing device. FIG. 5 illustrates an exemplary user interface screen 500 according to one such embodiment. As shown in FIG. 5, the user interface screen 500 includes a scan network button 502 and an automatic control device list 504.

According to an embodiment illustrated by FIG. 5, responsive to receiving an indication that a user has selected the scan network button 502, the mobile computing device executes a discovery process, such as the discovery process 400 described above. According to this embodiment, as part of the act 408, the user interface screen displays the name and IP address of each automatic control device that responded to the discovery request within the automatic control device list 504.

Also as describe above, other embodiments disclosed herein render user interface screens on a mobile computing device that receive login credentials. FIG. 6 illustrates an exemplary user interface screen 600 according to one such embodiment. As shown in FIG. 6, the user interface screen 600 includes text boxes 602 that identify the automatic control device to be accessed; text boxes 604 that receive User Name and Password strings; a check box 606 that receives an indication as to whether the mobile computing device should save the login credentials; and a login button 608.

According to an embodiment illustrated by FIG. 6, responsive to receiving an indication that a user has selected the login button 608, the mobile computing device attempts to establish trusted communications with the identified automatic control device using the login credentials.

Also as describe above, other embodiments disclosed herein render a menu screen via a user interface of a mobile computing device. FIG. 7 illustrates an exemplary menu screen 700 according to one such embodiment. As shown in FIG. 7, the menu screen 700 includes text boxes 702 that provide automatic control device identification and status information and actionable elements 704. The actionable elements 704, when actuated, cause the user interface to display screens presenting configuration information for the identified automatic control device. The configuration information accessible via the actionable elements 704 includes alert information (identified as “Alarm” in FIG. 7), ladder logic (identified as “Program” in FIG. 7), chart information (identified as “Chart” in FIG. 7), data table information (identified as “Data Tables” in FIG. 7), and rack information (identified as “Alarm” in FIG. 7). The chart information specifies user interface elements used to present information regarding process variables. The data table information specifies organizational structures for process variables. The rack information specifies the equipment connected to the automatic control device.

Also as describe above, other embodiments disclosed herein provide push notifications to the mobile computing device. FIG. 8 illustrates an exemplary user interface screen 800 including a push notification 802. As shown in FIG. 8, the push notification 802 includes a close button 804 and a view button 806. The close button, when actuated, removes the push notification from the user interface. The view button, when actuated, causes the mobile computing device to navigate to an alert screen where additional alert information is presented.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A system comprising:
a mobile computing device including:
a memory;
a network interface in data communication with a network; and
at least one processor coupled to the memory and the network interface; and
a control device interface executed by the at least one processor and configured to:
provide, via the network interface, a discovery request to at least one automatic control device of a plurality of automatic control devices in data communication with the network, the discovery request being encoded according to a first protocol;
receive, via the network interface, a response to the discovery request from the at least one automatic control device;
provide, via the network interface, a request for identification to the at least one automatic control device, the request for identification being encoded according to a second protocol;
receive, via the network interface, a response to the request for identification from the at least one automatic control device; and
identify the at least one automatic control device as an automatic control device based on the response to the request for identification, wherein the second protocol is an industrial protocol.

2. The system according to claim 1, wherein the control device interface is implemented as a native application resident on the mobile computing device.

3. The system according to claim 1, further comprising the at least one automatic control device, wherein the at least one automatic control device executes a web server and the control device interface is implemented via the web server and a web-browser resident on the mobile computing device.

4. The system according to claim 1, wherein the second protocol is at least one of MODBUS, UMAS, TCP/IP over Ethernet, BACnet, LON, C-BUS, DMX512, JCI-N2, and ZigBee.

5. The system according to claim 1, wherein the mobile computing device includes a user interface and the control device interface is further configured to display a representation of the at least one automatic control device within the user interface.

6. The system according to claim 1, wherein the control device interface is further configured to:
receive alert information; and
present a push notification including a representation of the alert information via the to user interface.

7. The system according to claim 1, wherein the control device interface is further configured to:
receive alert information;
store an alert representative of the alert information; and
present the alert via the user interface upon subsequent activation of the control device interface.

8. A method of discovering automatic control devices using a mobile computing device, the mobile computing device implementing a control device interface, the method comprising:
providing, via the control device interface, a discovery request to at least one automatic control device of a plurality of automatic control devices in data communication with the network, the discovery request being encoded according to a first protocol;
receiving a response to the discovery request from the at least one automatic control device;
providing a request for identification to the at least one automatic control device, the request for identification being encoded according to a second protocol;
receiving a response to the request for identification from the at least one automatic control device; and
identifying the at least one automatic control device as an automatic control device based on the response to the request for identification, wherein the second protocol is an industrial protocol.

9. The method of claim 8, wherein providing, via the control device interface, the discovery request includes providing the discovery request via a native application resident on the mobile computing device.

10. The method of claim 8, wherein providing, via the control device interface, the discovery request includes providing the discovery request via a web-browser resident on the mobile computing device.

11. The method of claim 8, wherein providing the request for identification includes providing to a request for identification using at least one of MODBUS, UMAS, TCP/IP over Ethernet, BACnet, LON, C-BUS, DMX512, JCI-N2, and ZigBee.

12. The method of claim 8, further comprising displaying a representation of the at least one automatic control device within a user interface.

13. The method of claim 8, further comprising:
receiving alert information; and
presenting a push notification including a representation of the alert information via a user interface.

14. The method of claim 8, further comprising:
receiving alert information;
storing an alert representative of the alert information; and
presenting the alert via a user interface upon subsequently activating the control device interface.

15. A non-transitory computer readable medium having stored thereon sequences of instruction for discovering automatic control devices in data communication with a network including instructions that will cause at least one processor of a mobile computing device to:
provide a discovery request to at least one automatic control device of a plurality of automatic control devices in data communication with the network, the discovery request being encoded according to a first protocol;
receive a response to the discovery request from the at least one automatic control device;
provide a request for identification to the at least one automatic control device, the request for identification being encoded according to a second protocol;
receive a response to the request for identification from the at least one automatic control device; and
identify the at least one automatic control device as an automatic control device based on the response to the request for identification, wherein the second protocol is an industrial protocol.

16. The computer readable medium according to claim 15, wherein the instructions cause the at least one processor to implement a native application on the mobile computing device.

17. The computer readable medium according to claim 15, wherein the instructions cause the at least one processor to encode the request for identification using at least one of MODBUS, UMAS, TCP/IP over Ethernet, BACnet, LON, C-BUS, DMX512, JCI-N2, and ZigBee.

18. The computer readable medium according to claim 15, wherein the instructions further instruct the at least one processor to display a representation of the at least one automatic control device within a user interface.

19. The computer readable medium according to claim 15, wherein the instructions further instruct the at least one processor to:
receive alert information; and
present a push notification including a representation of the alert information via the user interface.

20. The computer readable medium according to claim 15, wherein the instructions further instruct the at least one processor to:
receive alert information;
store an alert representative of the alert information; and
present the alert via a user interface upon subsequent activation of a control device interface.
